(19) United States
(12) Patent Application Publication
(10) Pub. No.: US 2003/0234043 A1
(43) Pub. Date: Dec. 25, 2003

(54) Anhydrous ammonia valve lock

(76) Inventor: Charles Lee Miller, Canon City, CO (US)

Correspondence Address: G. F. Gallinger, 7420 Milner Dr., Colorado Springs, CO, 80920, US

(21) Appl. No.: 10/178,844

(22) Filed: Jun. 25, 2002

(51) Int. Cl. F16K 27/08

(52) U.S. Cl. 137/382

(57) ABSTRACT

An apparatus and method of preventing theft of anhydrous ammonia used to produce methylene, a restricted narcotic. Most generally the method of theft prevention form a tank having an exterior discharge valve adapted for reception of a feed line comprising the steps of: providing a valve enclosure; installing the valve enclosure over and around the valve; removably installing the valve enclosure over and around the valve; and, locking the valve enclosure on the valve so that a feed line cannot be connected to a low pressure side of the valve. Most generally the valve enclosure includes a split housing which opens for mounting over and around the valve and lockably closes to prevent access to the valve.

### FIELD OF THE INVENTION

This invention relates to an apparatus and method of locking an outlet valve on a tank of anhydrous ammonia. More particularly this invention relates to an apparatus and method of locking the valve which will prevent theft of the ammonia by addicted individuals and individuals taking the ammonia to produce methamphetamine, a restricted narcotic.

### BACKGROUND OF THE INVENTION

The inventor was once addicted to narcotic drugs. Residing in Southern Colorado he became one of many young people with readily available access to anhydrous ammonia. Anhydrous ammonia is used as a nitrogen fertilizer by many farmers in rural areas. It is transported from a large pressurized tank in a supply depot in smaller tanks to farms and ultimately to the fields where it is injected into the ground. Tanks of ammonia are always available at the supply depot and frequently can be found on farms and in the fields where they are used.

The problem is that with less than $200. of readily available parts $10. of anhydrous ammonia can be converted to the addictive and restricted narcotic methamphetamine having a value exceeding $1000. Knowledge of the conversion process has become relatively widespread among a large group of young people. And because of the general availability of anhydrous ammonia the narcotic has become commonly available. Many high school students have graduated to a life of drub addiction with its accompanying devastation of their health and the general deterioration of their lives.

### OBJECTS OF THE INVENTION

It is an object of this invention to disclose a relatively simple and foolproof valve lock for a tank storing anhydrous ammonia. It is an object of this invention to disclose a valve lock which unlike other valve locks does not lock the valve in a closed position, but a valve lock which prevents the connection of a feed line to the low pressure side of the valve. It is yet a further object of this invention to disclose a method of interrupting the supply of anhydrous ammonia critical to the simple and inexpensive production of restricted narcotics. The supply of anhydrous ammonia is now abundant in rural areas where it is used for fertilizer. It is a final object of this invention to reduce the general availability and supply of a narcotic drug, methamphetamine, which has irreparably harmed and ruined the lives of many young people and through its increasing and inexpensive availability threatens to ruin the lives of many more.

One aspect of this invention provides for a method of preventing unauthorized removal of a fluid from a tank having an exterior discharge valve adapted for reception of a feed line comprising the steps of: providing a valve enclosure; installing the valve enclosure over and around the valve; removably installing the valve enclosure over and around the valve; and, locking the valve enclosure on the valve so that a feed line cannot be connected to a low pressure side of the valve.

In a preferred aspect of this invention the valve enclosure comprises a split housing which opens for mounting over and around the valve and lockably closes to prevent access to the valve. Most preferably the split through the housing passes through an inlet opening sized to closely fit around either a connecting member connecting the valve and the tank, or an inlet side of the valve. In a yet more preferred aspect of this invention no outlet opening is provided in the valve enclosure. A stem opening, through which the split in the housing passes through, allows the enclosure to be minimally sized. Because the enclosed valve can be opened and closed, a feed line must be removed from the valve prior to installation of the valve enclosure.

Various other objects, advantages and features of this invention will become apparent to those skilled in the art from the following description in conjunction with the accompanying drawings.

### FIGURES OF THE INVENTION

FIG. 1 is an elevational view of a discharge valve projecting from a tank of anhydrous ammonia.

FIG. 2 is a perspective view of a valve enclosure in an open position. The valve enclosure is adapted to surround the valve shown in FIG. 1, restricting access to the outlet of the valve.

FIG. 3 is an elevational view of the valve enclosure shown in FIG. 2 locked in a closed position over the valve shown in FIG. 1.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

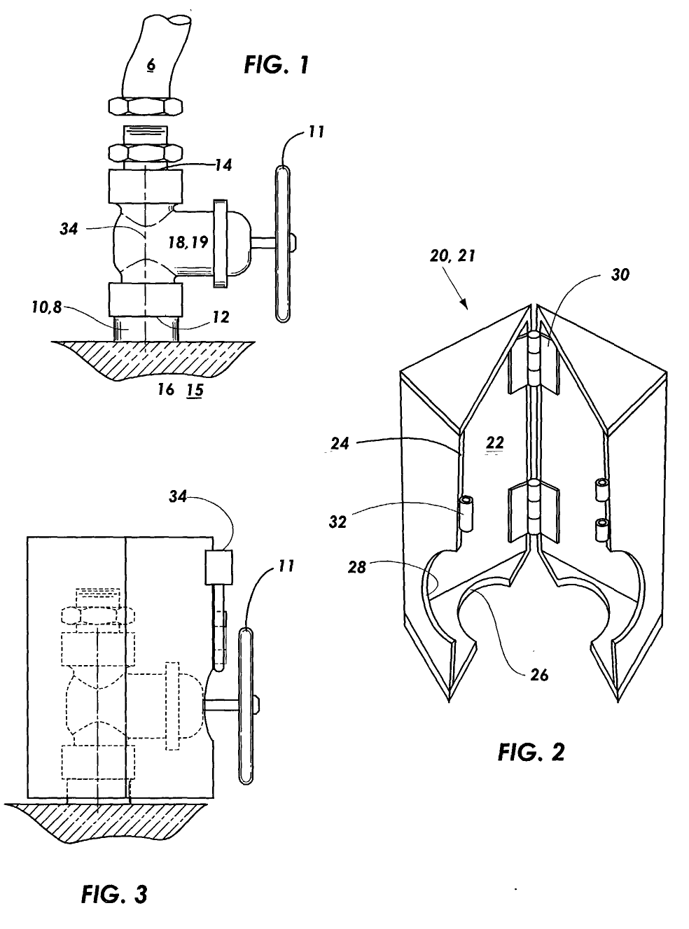

Turning now to the drawings and more particularly to FIG. 1 we have an elevational view of a discharge valve 18 projecting from a tank 16 of anhydrous ammonia. FIG. 2 is a perspective view of a valve enclosure 20 in an open position. The valve enclosure is adapted to surround the valve 18 shown in FIG. 1. The valve enclosure restricts access to the outlet side 14 of the valve 18.

Most generally the valve enclosure 20 is for a discharge valve 18 having an inlet side 12 connected to a tank outlet 10 and an outlet side 14 adapted for connection to a feed line 6. The valve enclosure comprises: a split housing 22 which opens for mounting over and around the valve 18 and lockably closes to prevent access to the valve 18. The split 24 through the housing 22 passes through an inlet opening 26 sized to closely fit around one of a connecting member 8 connecting the valve 22 and the tank 16, or an inlet side 12 of the valve 18.

In a preferred embodiment of the invention no outlet opening (not shown) is provided and a stem opening 28 through which the split 24 in the split housing 22 passes through. This allows the enclosure 20 to be minimally sized as the relatively large wheel 11 is accessible to open or close the valve 20. Accordingly, in use the feed line 6 must be removed from the valve 18 prior to installation of the valve enclosure 20 over and around the valve 18. when it is impossible to connect a feed line 6 to the valve 18 it is impossible for a thief to steal fluid 15 from the tank 16.

In a preferred embodiment of the invention the split portions of the enclosure 20 are hinged 30 together on one side and are each have mating lock shackle adaptions 32 on the other opposite side. When the valve 18 is an inline valve 19 having its inlet side 12 and its outlet side 14 in a line 34. And when the enclosure 20 is positioned on and over the valve 18 it generally has the hinges 30 on one side of the line 34 and the locking adaptions 32 on the other opposite side of the line 34. In the most preferred embodiment of the invention the enclosure 20 is generally box shaped and the box shaped enclosure 21 is diagonally split across two opposite end portions thereof. The box shaped enclosure 21 is fabricated from plate steel.

FIG. 3 is an elevational view of the valve enclosure 20 shown in FIG. 2 locked 34 in a closed position over the valve 18 shown in FIG. 1. A general method of preventing unauthorized removal of a fluid 15 from a tank 16 having an exterior discharge valve 18 adapted for reception of a feed line 6 comprises the steps of: providing a valve enclosure 20; removably installing the valve enclosure 20 over and around the valve 18; and, locking 34 the valve enclosure 20 on the valve 18 so that access to the valve 18 is prevented. A preferred method includes the steps in the general method above but additionally includes the step of removing the supply hose 6 prior to installing the valve enclosure 20 over and around the valve 18 so that after the valve 18 is enclosed a feed line 6 cannot be connected to a low pressure side 14 of the valve 18. More specifically this method includes using a valve enclosure 20 as described above.

While the invention has been described with preferred specific embodiments thereof, it will be understood that this description is intended to illustrate and not to limit the scope of the invention, which is defined by the following claims.

I claim:

1) A valve enclosure for a discharge valve having an inlet side connected to a tank outlet and an outlet side adapted for connection to a feed line comprising:
a split housing which opens for mounting over and around the valve and lockably closes to prevent access to the valve.

2) A valve enclosure as in claim 1 wherein the split through the housing passes through an inlet opening sized to closely fit around one of a connecting member connecting the valve and the tank, and an inlet side of the valve.

3) A valve enclosure as in claim 2 wherein no outlet opening is provided and further providing a stem opening through which the split in the housing passes through; so that in use the feed line must be removed from the valve prior to installation of the valve enclosure there over and around.

4) A valve enclosure as in claim 5 wherein the split passes centrally through the housing and wherein the split portions of the enclosure are hinged together on one side and are each have mating lock shackle adaptions on the other opposite side.

5) A valve as in claim 4 wherein the valve is an inline valve having its inlet and outlet side in a line and wherein the enclosure, when positioned on and over the valve, generally has hinges on one side of the line and the locking adaption on the other opposite side of the line.

6) An enclosure as in claim 5 which is generally box shaped and wherein the box is diagonally split across two opposite end portions thereof.

7) An enclosure as in claim 6 which is fabricated from plate steel.

8) A method of preventing unauthorized removal of a fluid from a tank having an exterior discharge valve adapted for reception of a feed line comprising the steps of:
providing a valve enclosure;
removably installing the valve enclosure over and around the valve; and,
locking the valve enclosure on the valve so that access to the valve is prevented.

9) A method as in claim 8 further comprising the step of removing the supply hose prior to installing the valve enclosure over and around the valve so that after the valve is enclosed a feed line cannot be connected to a low pressure side of the valve.

10) A method as in claim 9 further comprising the valve enclosure has a split housing which opens for mounting over and around the valve and lockably closes to prevent access to the valve.

11) A method as in claim 10 wherein the wherein no outlet opening is provided in the valve enclosure and further providing a stem opening through which the split in the housing passes through; so that in use a feed line must be removed from the valve prior to installation of the valve enclosure thereover and around.

12) A method as in claim 11 wherein the split passes centrally through the housing and wherein the split portions of the enclosure are hinged together on one side and are each adapted to receive s lock shackle on the other opposite side.

13) A method as in claim 12 wherein the valve is an inline valve having its inlet and outlet side in a line and wherein the enclosure, when positioned on and over the valve, generally has hinges on one side of the line and the locking adaption on the other opposite side of the line.

14) A method as in claim 13 wherein the enclosure is generally box shaped and wherein the box is diagonally split across two opposite end portions thereof.

15) A method as in claim 14 wherein the enclosure is fabricated from plate steel.
